(19) United States
(12) Patent Application Publication
(10) Pub. No.: US 2014/0218917 A1
(43) Pub. Date: Aug. 7, 2014

(54) LED Approach Light

(71) Applicant: Hella KGaA Hueck & Co., Lippstadt (DE)

(72) Inventors: Adam BARAN, Lippstadt (DE); Bernhard RUPPRATH, Lippstadt (DE)

(21) Appl. No.: 14/248,722

(22) Filed: Apr. 9, 2014

Related U.S. Application Data
(63) Continuation of application No. PCT/EP2012/069968, filed on Oct. 9, 2012.

(30) Foreign Application Priority Data
Oct. 10, 2011 (EP) 11184491.6

(51) Int. Cl. F21K 99/00

(52) U.S. Cl. CPC F21K 9/30
USPC 362/235

(57) ABSTRACT

An airport light for generating and elliptical beam of light and a method for generating such a beam of light is disclosed. The airport light has within a housing a first module with first LEDs, generating a first beam of light and a second module with a second LEDs, generating a second beam of light. The modules are mounted under an angle against each other resulting in non-parallel and partially overlapping beams of light from the LEDs

### PRIORITY CLAIM

This application is a continuation of pending International Application No. PCT/EP2012/069968 filed on 9 Oct. 2012, which designates the United States and claims priority from European Application No. 11184491.6 filed on Oct. 10, 2011. The contents of both of these applications are incorporated by reference in their entireties.

### BACKGROUND

1. Field of the Invention

The invention relates to LED airport lights, preferably used as approach center-line lights or crossbar lights. It also relates to a method for emulating an elliptical radiation pattern.

2. Description of Relevant Art

LED (light emitting diode) lighting systems offer significant advantages over traditional incandescent, HID and fluorescent lamps. LEDs are of smaller size, offer higher reliability, longer operational life and lower energy consumption. This is specifically important for airport lighting systems where high reliability and robustness is required. However, there are specific requirements when using LEDs. As increased operating temperature significantly reduces lifetime, cooling is of high importance. Furthermore, most LED chips are approximately isotropic light sources with a lambertian light distribution, which must be adapted to specific requirements of a lighting system.

Most airport lights, specifically approach centerline lights or crossbar lights have tightly specified radiation patterns. In general these have to comply with the ICAO standards.

In the US patent publication U.S. Pat. No. 6,932,496 B2 a LED-based elevated omnidirectional airfield light is disclosed. Light emitted by a centered LED is deflected radially by a mirror.

In the US patent publication U.S. Pat. No. 7,988,345 B2 a projection module of an automobile headlight is disclosed. Light emitted by LEDs is collimated and focused by a plurality of cascaded lenses to form a specific radiation pattern. This system may be adapted to a plurality of radiation pattern. The drawback is the very high complexity and resulting thereof high manufacturing costs and low reliability.

US patent application publication 2009/0016069 A1 discloses a high efficiency broad-beam light device. There, a plurality of individual LEDs are radially mounted to a circular printed circuit board. The light beam is guided through a circular lens forming an approximately circular light beam.

### SUMMARY

The embodiments are based on the object of providing a LED based airport light having a radiation pattern suitable for air-port lights, like approach centerline lights or crossbar lights, further having high optical power, high reliability and lifetime. Furthermore, the solution should be inexpensive and suitable for manufacturing in large volumes. A further problem to be solved is to provide an elliptical radiation pattern without complex lenses and mirrors.

In an embodiment, an airport light has at least first and second LEDs forming at least two light beams. The first LEDs are mounted to a first module while the second LEDs are mounted to a second module. The first module and the second module are mounted in an angle against each other. The LEDs thus emit non-parallel light beams. The angle between the modules is selected such, that the light beams of first LEDs and second LEDs partially overlap and thereby approximate an elliptical radiation pattern. The preferred angle between the modules is in the range of 6° to 30°. In a preferred embodiment the angle between the modules is 8°. This is specifically preferred when using LEDs with an angle of +−6° (equals 12° total) for 50% decrease of luminosity. This allows a simple and in expensive arrangement without complex and expensive optical means like lenses or reflectors. Although the resulting elliptical pattern is not perfect, it meets the minimum luminosity requirements of airfield lighting specifications like these issued by ICAO. In general the first and second modules may be any type of electronic module holding LEDs. In a very simple embodiment they may be printed circuit boards. They may also be mechanically structures holding the LEDs, while the LEDs are electrically connected by discrete wires or a printed circuit board, preferably a flexible printed circuit board. In a preferred embodiment, there is only one type of electronic module required. It is only necessary to mount the second module under an angle and rotated at 180° against the first module. The first and second modules are contained within a housing which preferably is made of metal to achieve good thermal conductivity. It preferably has a transparent cover which preferably is made of glass.

In another embodiment additional modules are provided. With further modules the luminosity can be increased. Furthermore the beam can be extended. For example it is possible to produce a comparatively broad and narrow ellipsis. Further modules may be arranged horizontally, vertically, or like a matrix.

In a preferred embodiment at least one of the first and second LEDs comprise of a plurality of LEDs, most preferably of 3 LEDs. For an improved approximation of the elliptical radiation pattern it is preferred, if the individual LEDs within at least one of first and second LEDs have slightly divergent light beams related to each other. This is also applicable to further modules.

In a further embodiment the housing has a module holder for holding the first of the second modules under the required angle. To adapt the radiation pattern to individual requirements only the module holder has to be changed. As the modules, or electronic modules have not to be changed, they can be manufactured in large quantities thus reducing manufacturing costs.

Another embodiment relates to a method for emulating an elliptical radiation pattern by LEDs which typically have a circular radiation pattern. The method comprises arranging first LEDs and second LEDs under an angle to obtain a first beam of light from the first LEDs and a second beam of light from the second LEDs. The first beam of light and the second beam of light are under the angle and form at least partially overlapping radiation patterns. Preferably the angle between the first and second LEDS is in the range of 6° to 30°.

In a preferred embodiment each of the LEDs is mounted at an individual module, and the modules are arranged under an angle relative to each other, defining the angle between the LEDs.

In another embodiment additional modules are provided. With further modules the luminosity can be increased. Furthermore the beam can be extended. For example it is possible to produce a comparatively broad and narrow ellipsis.

In a further embodiment, at least one of the first and second LEDs comprise of a plurality of LEDs, most preferably of 3 LEDs. For an improved approximation of the elliptical radiation pattern it is preferred, if the individual LEDs within at least one of first and second LEDs have slightly divergent light beams related to each other. This is also applicable to further modules.

### BRIEF DESCRIPTION OF THE DRAWINGS

In the following, the invention will be described by way of example, without limitation of the general inventive concept, on examples of embodiment and with reference to the drawings.

FIG. 1 shows a first embodiment.

FIG. 2 shows a radiation pattern as required by standards.

FIG. 3 shows the approximation of an elliptical radiation pattern by circular radiation patterns.

FIG. 4 shows the light beams approximating an elliptical radiation pattern.

FIG. 5 shows an exemplary arrangement of LEDs.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

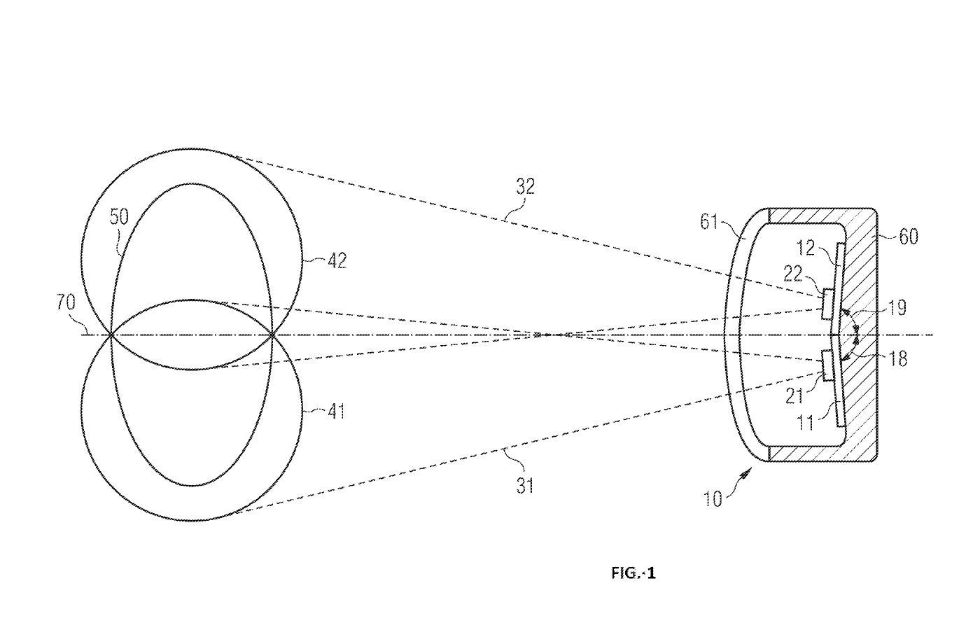

FIG. 1 shows a first embodiment. The airport light 10 comprises a housing 60 which preferably is made of metal like aluminum to provide a good thermal conductivity. The housing is closed by a transparent cover 61 which preferably is made of glass. Inside the housing are a first module 11 and a second module 12. The first module 11 holds first LEDs 21, while the second module 12 holds second LEDs 22. There may be additional electronic components like resistors, diodes or LED drivers on the modules. The first module 11 and the second module 12 are mounted under an angle against each other. This results in a first angle 18 between the first module 11 and a center axis 70 different from 90°. Furthermore the second angle 19 between the second module 12 and the center axis 70 is also different from 90°. As shown herein both angles are smaller than 90°. The angles may also be larger than 90°. The deviation of the angles from 90° is preferably in a range from 3° to 15°, resulting in an angle between the boards in a range from 6° to 30°. Most preferably the deviation is between 5° and 10°. The angles of the modules define the radiation angles of the LEDs attached thereto with respect to the center axis 70. The light beam 31 of first LEDs 21 result in first LEDs radiation pattern 41. The light beam 32 of second LED 22 recited in second LEDs radiation pattern 42. By superimposing the first and the second radiation pattern, the minimum required luminosity as shown by the elliptical radiation pattern 50 can be maintained.

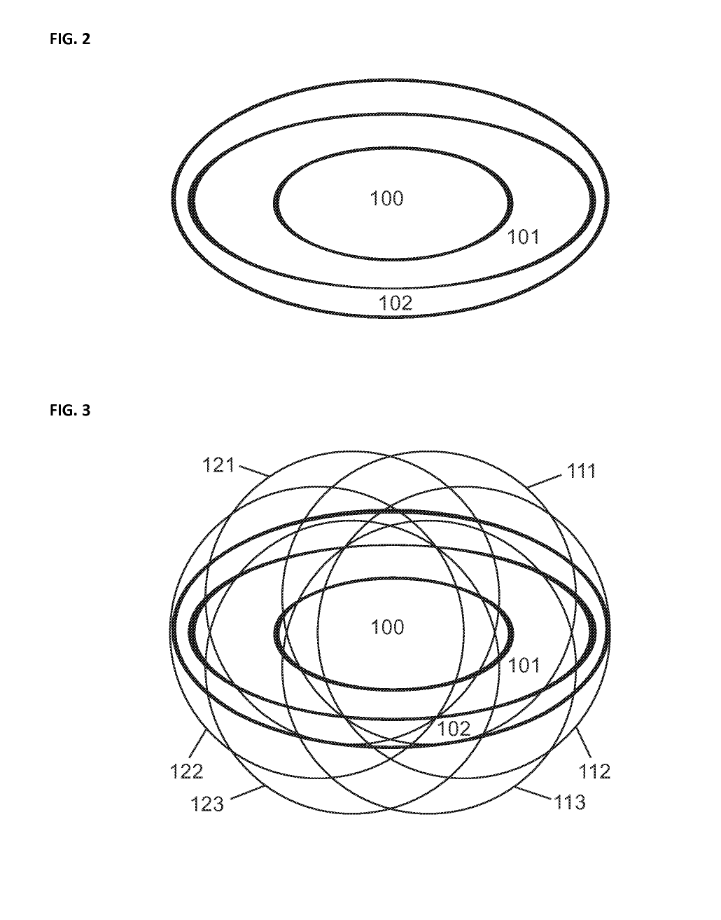

In FIG. 2 a radiation pattern is shown as required by ICAO standards for approach centerline lights and for crossbar lights. The main beam 100 has an elliptical shape and is within a horizontal angular range of −10 degrees (left side) to +10 degrees (right side). The vertical range is from 2.5 degrees above ground (bottom) to 13.5 degrees. The luminosity of the main beam must not exceed 10000cd. There further a first outer beam 101 and a second outer beam 102. The luminosity is decreasing from the main beam to the outer beams.

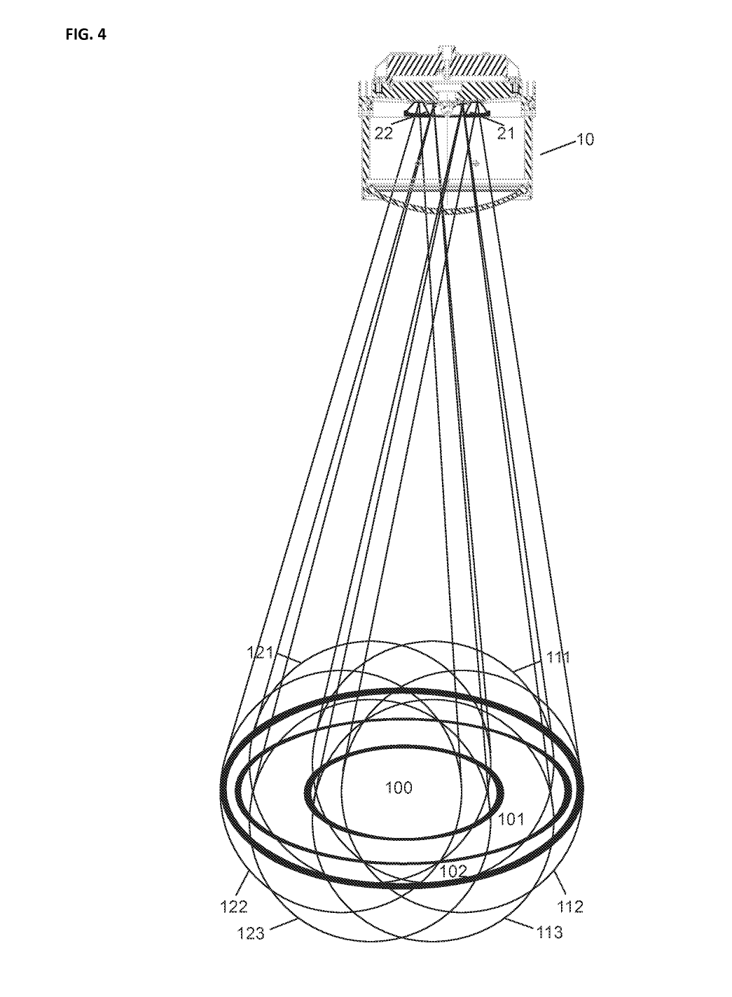

FIG. 3 shows the approximation of the above elliptical radiation pattern by two groups of circular radiation patterns. The first group of circular radiation patterns comprises radiation patterns 111, 112 and 113 which are generated by first LEDs 21. The second group of circular radiation patterns comprises radiation patterns 121, 122 and 1 to 3 which are generated by second LEDs 22. By super-imposing the radiation of six LEDs a comparatively good approximation of the required elliptical radiation pattern can be achieved. For example in the center area of the main beam light of all six LEDs is superimposed, resulting in the highest luminosity. In the outer areas like in the area of second outer beam 102 there is light of the lower number of LEDs superimposed. For example at the right and the left side there is only light of one LED 112- or 122.

In FIG. 4 the light beams for the radiation pattern are shown. The light being emitted from the first LEDs 21 results in radiation patterns 111, 112 and 113. The light being emitted from the second LEDs 22 recited radiation pattern 121, 122 and 123.

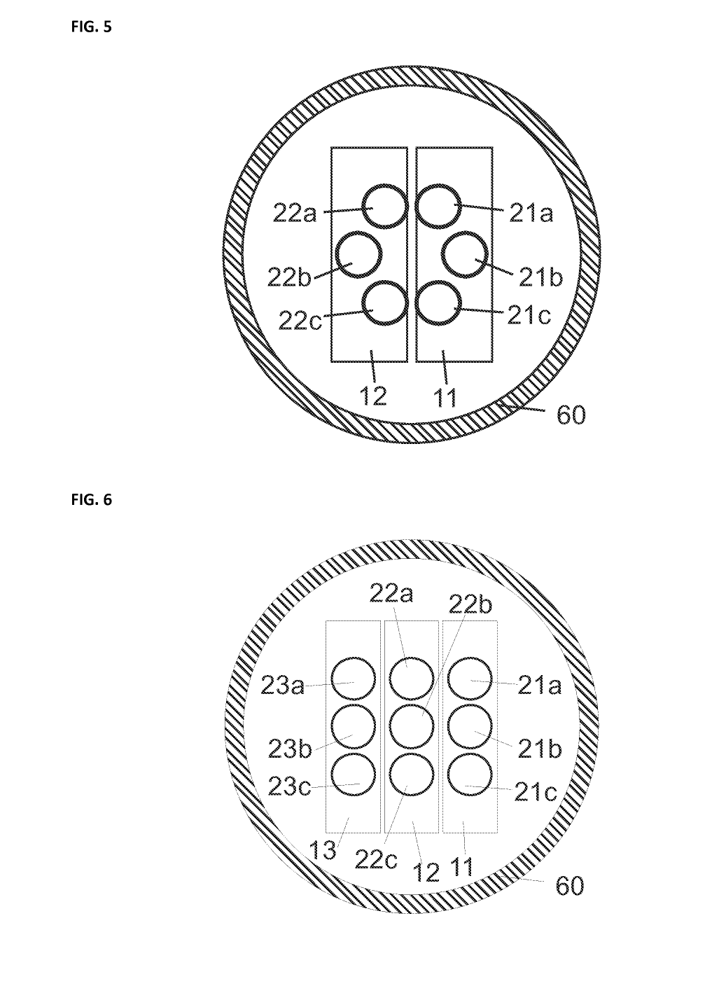

In FIG. 5 an exemplary arrangement of LEDs is shown. Here first LEDs 21a, 21b and 21c are arranged on first module 11. Second LEDs 22a, 22b and 22c are arranged on the second module 12. Such an arrangement of LEDs may produce a radiation pattern as described above.

In FIG. 6 an arrangement of 3 LED modules is shown. Here first LEDs 21a, 21b and 21c are arranged on first module 11. Second LEDs 22a, 22b and 22c are arranged on the second 20 circuit board 12. Third LEDs 23a, 23b and 23c are arranged on the third module 13. Such an arrangement of LEDs may produce a broader radiation pattern as described above.

It will be appreciated to those skilled in the art having the benefit of this disclosure that this invention is believed to provide LED airport lights. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 airport light

11 first module

12 second module

13 third module

18 first angle

19 second angle

21 first LEDs

22 second LEDs

23 third LEDs

31 beam of light by first LEDs

32 beam of light by second LEDs

41 first LEDs radiation pattern

42 second LEDs radiation pattern

50 required elliptical radiation pattern

60 housing

61 transparent cover

70 center axis

100 main beam

101 first outer beam

102 second outer beam

111, 112, 113 radiation patterns of first LEDs

121, 122, 123 radiation patterns of second LEDs

1. An airport light comprising:
at least a housing coupled to a transparent cover, the housing containing:
a first module with a first light-emitting diode (LED) light source configured to generate a first beam of light,
a second module with a second LED light source configured to generate a second beam of light,
wherein:
the first module is mounted at an angle to the second module such that the first beam of light is not parallel to and partially overlaps the second beam of light,
at least one of the first LED light source and/or the second LED light source comprise a plurality of LEDs , and
the partially overlapping first and second beams of light approximate an elliptical radiation pattern.

2. The airport light of claim 1, further comprising a third module with a third LED light source configured to generate a third beam of light that partially overlaps at least one of the first beam and the second beam.

3. The airport light of claim 1, wherein at least the first LED light source and the second LED light source each comprises three LEDs.

4. The airport light of claim 1, wherein the housing comprises metal.

5. A method for emulating an elliptical radiation pattern with light-emitting diode (LED) light sources each having a circular radiation pattern, the method comprising:
arranging a first LED light source at a non-parallel angle relative to a second LED light source to generate a first beam of light from the first LED light source and a second beam of light from the second LED light source, such that the first beam of light and the second beam of light at least partially overlap,
wherein:
at least one of the first LED light source and/or the second LED light source comprise a plurality of LEDs,
each of the LED light sources is mounted at an individual module, and
the modules are arranged at an angle relative to each other to define the angle between the first and second LED light sources.

6. The method according to claim 5, wherein the angle between the first and second LED light sources is in the range of 6° to 30°.

7. The method according to claim 5, wherein at least a third module with a third LED light source generates a third beam of light that partially overlapps at least one of the first beam and the second beam.

8. The method according to claim 5, wherein at least the first LED light source and the second LED light source each comprises three LEDs.
